(19) United States
(12) Patent Application Publication
(10) Pub. No.: US 2012/0216756 A1
(43) Pub. Date: Aug. 30, 2012

(54) Paw Pal - Injured paw protector

(76) Inventor: Lynn Ellen Wells, Las Vegas, NV (US)

(21) Appl. No.: 12/134,817

(22) Filed: Jun. 6, 2008

(51) Int. Cl. A01K 13/00

(52) U.S. Cl. 119/850

(57) ABSTRACT

PAW PAL: Fabric protection for paw or other extremity injuries including surgical incisions, i.e.: neuter incisions, or laceration injuries. Options include medicated pads or inserts as required. The simple yet efficient design and application results in previously unobtainable speed of healing and other recovery factors, while allowing the injured pet (or other animal) to continue his normal lifestyle, nearly unaware of the inventions application. This embodiment completely outdates previously utilized paw or other extremity injury protection methods because of its extreme simplicity and efficiency and ease of use for all involved. The use of the “Elizabethan Collar” becomes obsolete, if necessary at all. The method (Elizabethan Collar) had become the gold standard for treatment of family pets, and is surely loathed by all (including the pets prescribed the treatment) because of its inhumane and ineffective treatment of pets, for extended periods of time. PAW PAL is proven in several actual pet injuries.

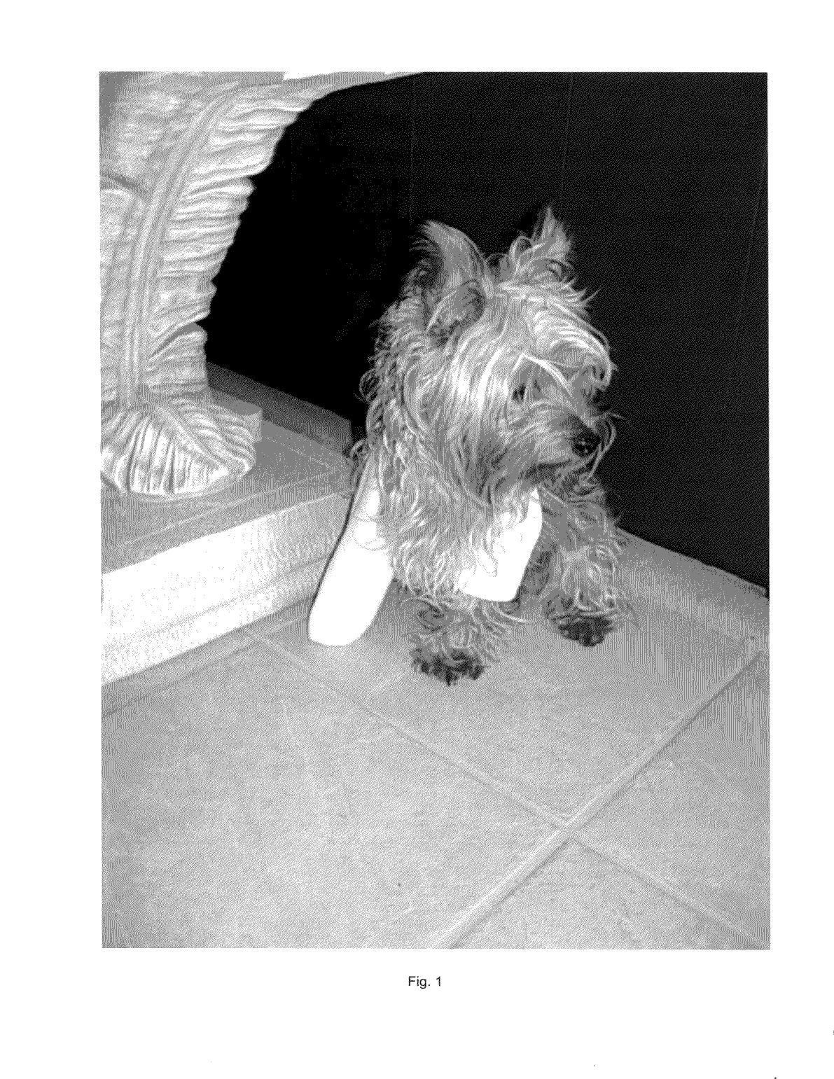

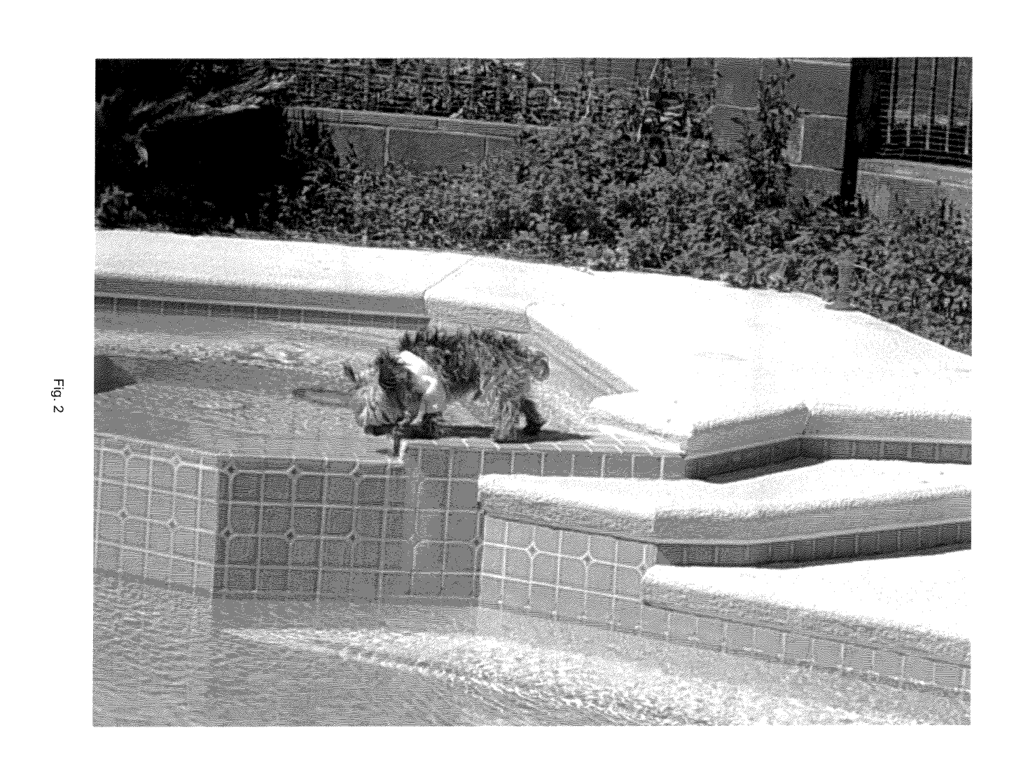

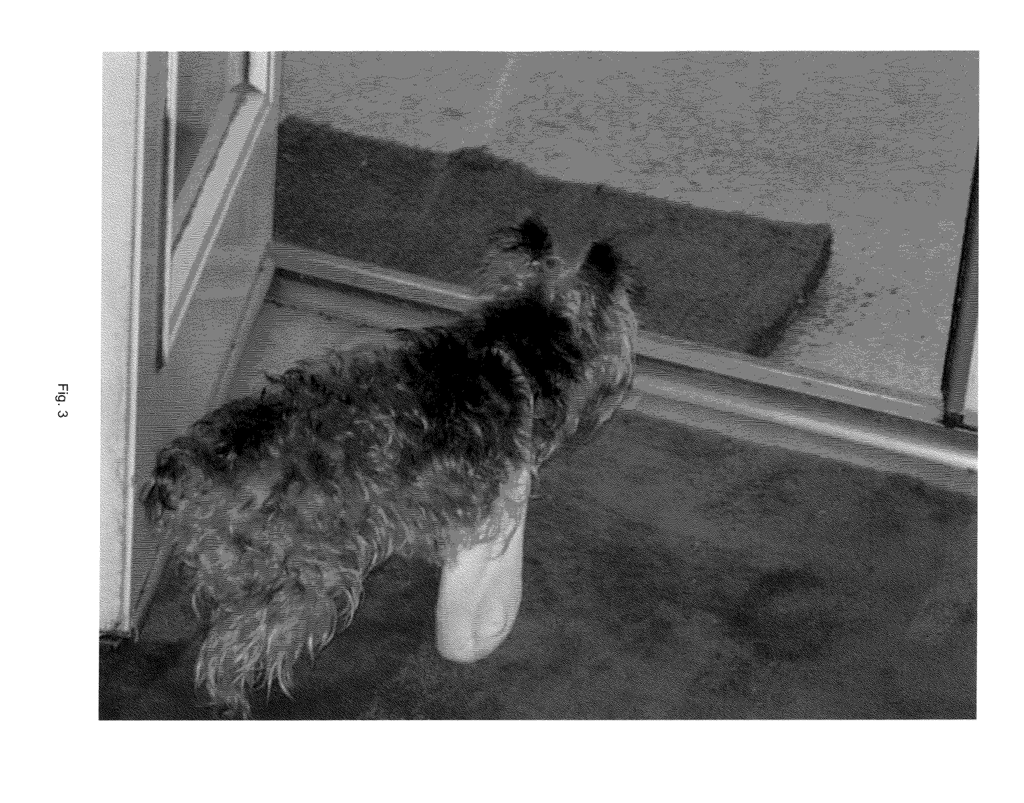

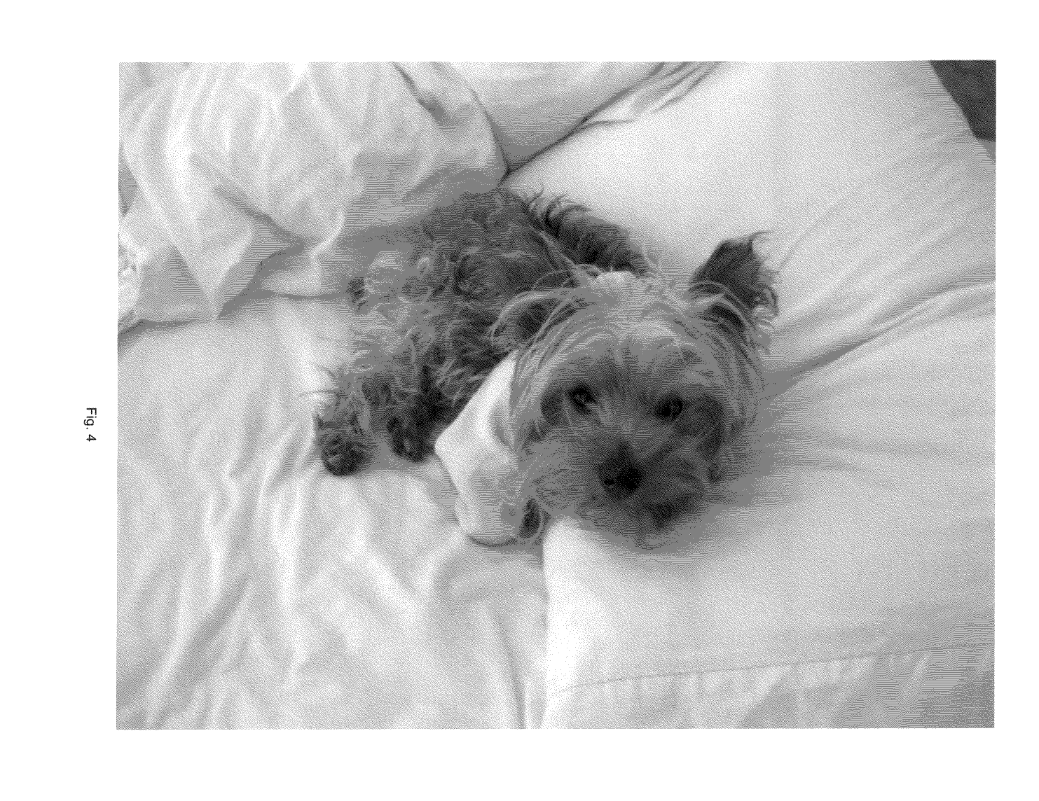

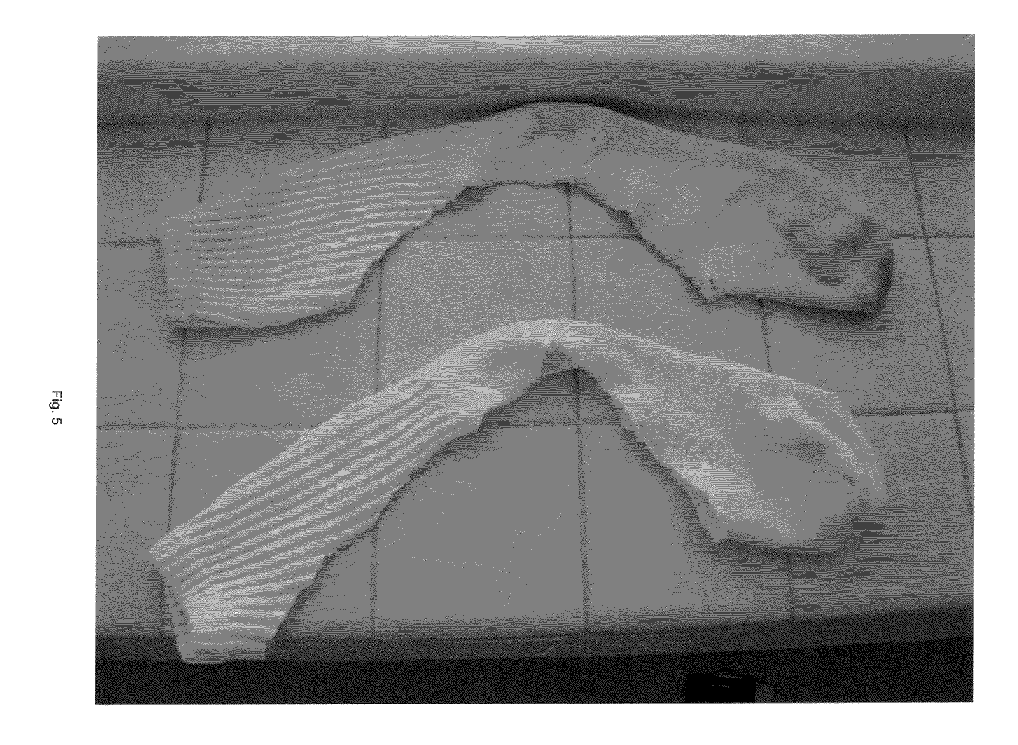

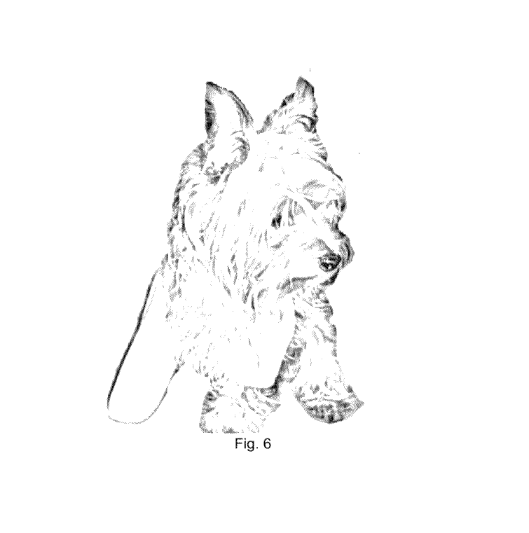

PAW-PAL (Paw Pal): Protector for Injured paw, surgical incision or other extremity or laceration. Applicable to four (4) legged pets and other non-household animals.

### PRIORITY INFORMATION

Not applicable

### FIELD OF THE INVENTION

This invention relates to Pet Injury Protection device

### BACKGROUND OF THE INVENTION

For use in the protection of and healing process involving a pet (or other animal) paw, incision or other injury. The invention greatly enhances the healing process due to the simple, unencumbered embodiment of the device. No similar devices existed prior to the invention of the Paw Pal.

The invention resulted from a negative experience involving a cut in a family dog's paw-pad that remained unhealed after extended treatment under the auspices of a local Veterinarian. The negative, unsuccessful treatment involved the “Elizabethan Collar” along with medicated creams. After two weeks of use of the horrific Elizabethan Collar, no discernable healing had occurred to the wound, and in fact, additional damage to the injured area resulted, for two reasons: First, the cut was unprotected from the daily activities of the pet by the “Elizabethan Collar”, which was actually useless in this instance. Secondly, the pet was able to instinctively lick the wound, furthering the injury. Owner applied bandages to the injured paw were ineffective. The accepted practice failed completely to protect the pets injured paw.

Within five days of using the Paw Pal, the family pet, Woogie, a small Yorkie, was nearly completely healed while he engaged in his regular daily activities including using this Doggie Door; playing energetically at the Dog Park with many other dogs; daily walks; etc. Woogie actually played in and near the family swimming pool with no adverse effects. Alternate applications were beta tested by others at the Dog Park with similar positive results. The Paw Pal was an instant hit among fellow pet owners, who immediately saw the advantages to its use.

### BRIEF SUMMARY OF THE INVENTION

The invention is a fabric device which protects a dog or pet paw injury or other surgical incision or topical injury with extreme efficacy and ease of use for the dog and the caretaker.

This embodiment consists of a fabric protective device consisting simply of a tubular fabric “bandage”, enclosed on one end, and either open or enclosed on the opposite end, depending on the application. In one embodiment, the device straddles the shoulders to right and left front paws—the enclosed end of the invention encasing the injured paw while the opposite paw “secures” the paw protector through simple compression. Alternatively, both ends of the invention may be enclosed while stretched over the animals' torso providing protection to two extremities. This embodiment can use either a front-paw to front-paw application or a front-paw to alternate rear-paw application. Additionally, all four extremities can be protected with a four-pronged embodiment of the invention stretched diagonally over the torso of the animal. In as-needed situations the required compression can be obtained by involving the animals tail as an anchor point.

Each and every application described still allows extremely simple utilization. In the application involving a surgical incision or other external laceration, a variation of attachment points or extremities may be used providing sufficient pressure to protect the affected area from external processes. The device in its basic form is manufactured of cotton blends allowing movement sufficient to secure both ends of the tubular manifestation after stretching the device from the injured paw (or appendage) to the opposing non-injured appendage; or, from one injured paw (or appendage) to another opposing injured paw, as may be the case. Because the device is so simple in design and use, it fits snugly, safely and securely on the dogs body, providing unencumbered protection and if needed, medication application for the dog (or other animal) while allowing a regular standard of lifestyle and activity. Four or five basic sizes; each somewhat adjustable within its inherent parameters will suffice for 99̂ of dog sizes. Alternately, a scored, templated option will allow for multiple size alternatives with one basic adjustable version. One-size-fits-many option, although secondary to the best-fit-option, provides tear-off adjustment to a basic multi-sized version.

The device is so unobtrusive that the dog (or other animal) is unaffected by its presence; allowing a safe and active environment for healing and protection from not obnly the actual would, but from the animals natural instinct to lick the would, resulting in additional injury and extended recovery time.

Another benefit of the invention is protection to other animals within the area of the injured pet (animal).

The invention can be applied to household pets and wild animals as necessary.

The simple nature of the device makes it use preferable to other means and methods of protecting a paw or extremity would in terms of unhindered, unobstructed, unlimited, unhampered nearly indiscernible yet successful protection while leaving the dog free to continue his daily activities.

This invention provides ease of cleaning and application of medications, if required, to the would due to its simple on/off mechanics; addition of medicated or additional protective pads and inserts inside the protected paw portion of the device adds additional value to this embodiment.

The cost of the device is reasonably low. Design makes the device interchangeable between left and right paws; and design options allow for alternate left/right-front/back applications and multiple extremity/incision applications to address rear paws and additionally injuries to other specific body parts of the animal (back, shank, neuter incisions, etc).

The Elizabethan Collar, which has become the gold standard, will be replaced by Paw-Pal, has so many negative elements that its use is questionable except in extreme, life-challenging or otherwise specific situations. Inordinately simple in design and use and resulting success.

No Velcro or other adhesive(s) (tapes) are required which may injure the animal by pulling hair or skin or catching on ambient objects.

Simple use by the animal. Protects the injured paw (or other extremity or incision) while allowing the animal to carry on his standard of daily activity; walking, running, utilizing “doggie doors”, swimming, playing at dog parks; with no apparent consciousness of the device protecting the injured extremity or body part.

The invention provides a desired environment for not only the dog (or other animal) but also the dog's owners and caretakers and pet siblings also.

1. Four (4) legged animal paw injury or incision/laceration protector with option for medicated pads or other additions. No such device exists, providing such successful and easy protection of an injured paw or paw-pad or other 4-legged animal extremity or incision or operation (neuter/spay) site.

2. The method of claim 1, wherein prevention of the licking instinct alone, is worthy of acclaim—this natural instinct further injures existing cuts or other injuries preventing healing and promoting infection.

3. The method of claim 1, wherein use of the PawPal provides the animal user unobstructed regular use of a Doggie Door and other rambunctious active physical interaction with other dogs (i.e. at dog parks) (unlike Elizabethan collar).

4. The method of claim 1, wherein the invention can be worn during sleep.

5. The method of claim 1, wherein, the invention is extremely simple to use and maintain allowing ease of cleaning of the extremity.

6. The method of claim 1, wherein the invention enables medicinal application, as needed.

7. The method of claim 1, wherein the invention can be easily washed and reused with an existing injury or subsequent unrelated injury or incision.

8. The method of claim 1, wherein the invention, in an actual test case involving a rather severe cut to a dogs paw-pad which had remained unhealed what-so-ever after two weeks of existing care including the use of an “Elizabethan Collar” healed nearly completely in 5 days using on the “Paw Pal” and a topical medicated spray. Both the dog (Woogie) and his owner were extremely excited.

9. The method of claim 1, wherein Invention eliminates use of and provides alternative to “Elizabethan Collar” which is distressing and unsafe not only for the dog or other pet, but the caretaker, also.
